(19) United States
(12) Patent Application Publication
(10) Pub. No.: US 2018/0349871 A1
(43) Pub. Date: Dec. 6, 2018

(54) Bill Payment System and Method

(71) Applicant: Gelliner Limited, Douglas (IM)

(72) Inventor: Martin Paul Moshal, Queens Way Quay (GI)

(21) Appl. No.: 15/503,767

(22) PCT Filed: Aug. 14, 2015
(86) PCT No.: PCT/GB2015/052350

§ 371 Date: Feb. 14, 2017

(30) Foreign Application Priority Data
Aug. 15, 2014 (GB) 1414511.4

(51) Int. Cl. G06Q 20/14; G06Q 20/20; G06K 19/06

(52) U.S. Cl. CPC G06Q 20/14; G06K 19/06037; G06Q 20/20

(57) ABSTRACT

A device receives a file representing a bill, augments at least a portion of the received file to include data representing a non-textual representation of (i) the bill and (ii) a merchant identifier, and sends the augmented file to an output device. A server may receive, from the device, data representing the bill and receive, from a computing device, a request to initiate payment. The server may then initiate payment, determine whether payment of the bill was successful, and send a message indicating whether payment of the bill was successful to the computing device. The computing device may detect the non-textual representation and display information related to the bill. The computing device may also receive input representing a command to initiate payment of at least a portion of a total amount due corresponding to the bill and send, to the server, a request to initiate payment.

### BACKGROUND

Unless otherwise indicated herein, the elements described in this section are not prior art to the claims and are not admitted to be prior art by inclusion in this section.

Bill payment at establishments such as restaurants, refuelling stations and retailers can be tedious and time-consuming. For example, at a restaurant, when a diner is presented with a bill at the conclusion of a meal, the diner can tender cash or a tangible payment instrument (such as a credit or debit card) to an employee to pay the bill. The employee is then required to provide change if payment is by cash, or to use a POS terminal if a payment instrument is used (e.g., a card swipe).

A further illustration of the tediousness of bill payment occurs where a diner elects to add a discretionary gratuity (or “tip”) to the bill total as a reward for good service, or elects to deduct or alter an optional gratuity that is already reflected in the bill total. Still further, the diner may wish to split the bill total, with or without a gratuity, equally with fellow-diners, or the diners may agree that each person pays for the items on the bill that each person has consumed.

The applicant has appreciated the desirability of a simpler process for paying bills than that described above.

### OVERVIEW

Example embodiments are described herein.

In one respect, an example embodiment takes the form of a method comprising receiving, by a data analyser device from a point-of-sale (POS) device, a file including data that represents a textual representation of a bill from a merchant; augmenting at least of portion of the received file to include data representing a non-textual representation of (i) the bill and (ii) a merchant identifier corresponding to the merchant, thereby generating an augmented file; and sending the augmented file away from the data analyser device to an output device.

In another respect, an example embodiment takes the form of a method comprising receiving, by a server from a data analyser device, data representing a bill from a merchant; receiving, from a computing device, a request to pay at least a portion of an amount due corresponding to the bill; initiating, by the server, payment of the bill based on receiving the request; determining, by the server, whether payment of the bill was successful; and sending, by the server, a message indicating whether payment of the bill was successful to the computing device.

In yet another respect, an example embodiment takes the form of a method comprising detecting, by a computing device, a non-textual representation of (i) a bill from a merchant and (ii) a merchant identifier, wherein the non-textual representation is generated by a data analyser device augmenting at least a portion of a received file representing the bill to generate an augmented file that is sent to an output device; based on the detected representation, displaying information related to the bill by a user-interface of the computing device; receiving, by the user-interface, input representing a command to initiate payment of at least a portion of a total amount due corresponding to the bill; and based on receiving the input, sending, to a server, a request to initiate payment of at least a portion of the total amount due.

In yet another respect, an example embodiment takes the form of a computer-readable medium storing instructions that when executed by a data analyser device cause the data analyser device to perform functions comprising receiving from a point-of-sale (POS) device, a file including data that represents a textual representation of a bill from a merchant; augmenting at least of portion of the received file to include data representing a non-textual representation of (i) the bill and (ii) a merchant identifier corresponding to the merchant, thereby generating an augmented file; and sending the augmented file away from the data analyser device to an output device.

In yet another respect, an example embodiment takes the form of a computer-readable medium storing instructions that when executed by a server cause the server to perform functions comprising: receiving, from a data analyser device, data representing a bill from a merchant; receiving, from a computing device, a request to pay at least a portion of an amount due corresponding to the bill; initiating payment of the bill based on receiving the request; determining whether payment of the bill was successful; and sending a message indicating whether payment of the bill was successful to the computing device.

In yet another respect, an example embodiment takes the form of a computer-readable medium storing instructions that when executed by a computing device cause the computing device to perform functions comprising: detecting a non-textual representation of (i) a bill from a merchant and (ii) a merchant identifier, wherein the non-textual representation is generated by a data analyser device augmenting at least a portion of a received file representing the bill to generate an augmented file that is sent to an output device; based on the detected representation, displaying information related to the bill by a user-interface of the computing device; receiving, by the user-interface, input representing a command to initiate payment of at least a portion of a total amount due corresponding to the bill; and based on receiving the input, sending, to a server, a request to initiate payment of at least a portion of the total amount due.

In yet another respect, an example embodiment takes the form of a data analyser device comprising: a processor; and a computer-readable medium storing instructions that when executed by the processor cause the data analyser device to perform functions comprising: receiving, from a point-of-sale (POS) device, a file including data that represents a textual representation of a bill from a merchant; augmenting at least of portion of the received file to include data representing a non-textual representation of (i) the bill and (ii) a merchant identifier corresponding to the merchant, thereby generating an augmented file; and sending the augmented file away from the data analyser device to an output device.

In yet another respect, an example embodiment takes the form of a server comprising: a processor; and a computer-readable medium storing instructions that when executed by the processor cause the server to perform functions comprising: receiving, from a data analyser device, data representing a bill from a merchant; receiving, from a computing device, a request to pay at least a portion of an amount due corresponding to the bill; initiating payment of the bill based on receiving the request; determining whether payment of the bill was successful; and sending a message indicating whether payment of the bill was successful to the computing device.

In yet another respect, an example embodiment takes the form of a computing device comprising: a processor; and a computer-readable medium storing instructions that when executed by the processor cause the computing device to perform functions comprising: detecting a non-textual representation of (i) a bill from a merchant and (ii) a merchant identifier, wherein the non-textual representation is generated by a data analyser device augmenting at least a portion of a received file representing the bill to generate an augmented file that is sent to an output device; based on the detected representation, displaying information related to the bill by a user-interface of the computing device; receiving, by the user-interface, input representing a command to initiate payment of at least a portion of a total amount due corresponding to the bill; and based on receiving the input, sending, to a server, a request to initiate payment of at least a portion of the total amount due.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the drawings, in which:

FIG. 1 is a schematic representation of a system for bill payment;

FIG. 2 illustrates an example non-textual representation of a (i) bill and/or (ii) a merchant identifier;

FIG. 3 is a block diagram of a computing device in accordance with an example embodiment;

FIG. 4 is a block diagram of a data analyser device in accordance with an example embodiment;

FIG. 5 is a block diagram of a server in accordance with an example embodiment;

FIG. 6 is a flow chart of functions to carry out bill payment in accordance with an example embodiment; and

FIG. 7 is a flow chart of functions to carry out bill payment in accordance with an example embodiment.

### DETAILED DESCRIPTION

### I. Introduction

This description describes, among other things, example embodiments with respect to paying a bill at a merchant establishment. In this description, the articles “a” or “an” are used to introduce elements of the example embodiments. The intent of using those articles is that there is one or more of the elements. The intent of using the conjunction “or” within a described list of at least 2 terms is to indicate that any of the listed terms or any combination of the listed terms. The terms “first,” “second,” and “third” are used to distinguish respective elements and are not used to denote a particular order of those elements.

The following abbreviations or acronyms are used in the description:

Analyser App—Data analyser device Application Program;

CRPI—computer-readable program instructions;

CVC—Card Verification Code;

e.g.—for example;

FIG.—Figure;

FIGs.—Figures;

Inc.—Incorporated;

PIN—Personal Identification Number;

POS—Point-of-Sale;

QR—Quick Response; and

Scanner App—Scanner Application Program.

### II. Example Architecture

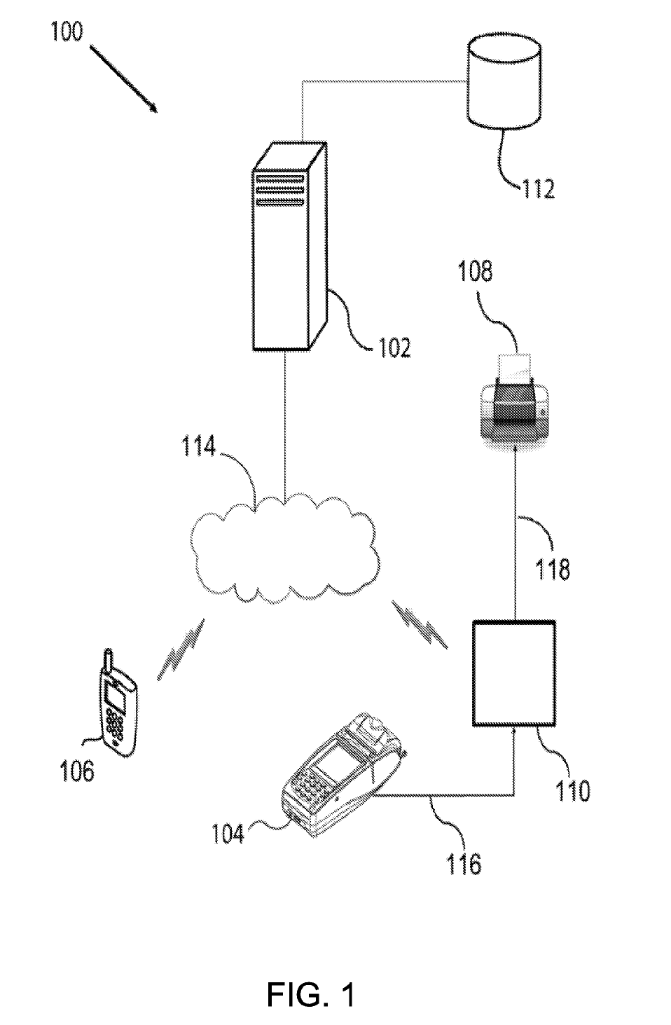

FIG. 1 depicts a schematic representation of a system 100 for bill payment in accordance with example embodiments described herein. The system 100 includes a server 102, a POS device 104, a computing device 106, an output device 108 and a data analyser device 110, and a bills database 112.

The computing device 106 is configured to detect (e.g., scan) and decode non-textual representations of data such as a two-dimensional matrix barcode (or more simply, a “2D matrix barcode” or a “2D matrix code.”) A 2D matrix code can include, but is not limited to, a data matrix code that conforms to an International Organization for Standardization (ISO) standard, such as the ISO 16022:2006 standard (Information technology—Automatic identification and data capture techniques—data matrix bar code symbology specification), the ISO 18004:2006 standard (Information technology—Automatic identification and data capture techniques—QR code 2005 bar code symbology specification), also known as a Quick Response code (or more simply a “QR code”) readable by a QR CODE® barcode scanner, or some other type of 2D matrix code. The computing device 106 can include or take the form of a conventional smartphone handset provisioned with software for (i) detecting 2D matrix codes or other non-textual representations of data, (ii) a web browser, and (iii) a wireless or wired connection to the internet. The computing device 106 can be referred to as a “mobile wireless communication device,” a “mobile smartphone handset” or, more simply, a “mobile smartphone” or “smartphone.” As an example, the mobile wireless communication device can be or include a personal digital assistant, a tablet computer, or a cellular telephone.

The output device 108 can include or take the form of a printer, a handheld computing device, or a display monitor, among other possibilities. In an example where the output device 108 is a printer, the printer may be configured to produce a printed copy of a 2D matrix code or another non-textual representation of data. Or, the output device 108 could be or include a handheld computing device having a display screen suitable to be carried by an employee to show non-textual representations of data to customers or users at their table, for example.

The data analyser device 110 may be configured to receive a file representing a bill sent from the POS device 104, to augment the received file with data representing a non-textual representation of the bill and a merchant identifier, and to send the augmented file to the output device 108. The data analyser device 110 can include or take the form of a microcomputer provisioned with software for encoding 2D matrix codes, and a wired or wireless connection to the internet. The data analyser device 110 can also be referred to as an “interceptor”. As an example, the data analyser device can include a Raspberry Pi sold by, among others, RS Components, Corby, United Kingdom and Newark Element14, Chicago, Ill., United States.

The server 102, the computing device 106 and the data analyser device 110 can communicate with each other using a communication network 114. The communication network 114 can comprise a wide-area network, such as the internet. The data analyser device 110 can communicate with the POS device 104 and with the output device 108 by means of communication channels 116 and 118, respectively. The communication channels 116 and 118 can be wired or wireless serial communication channels, among other possibilities.

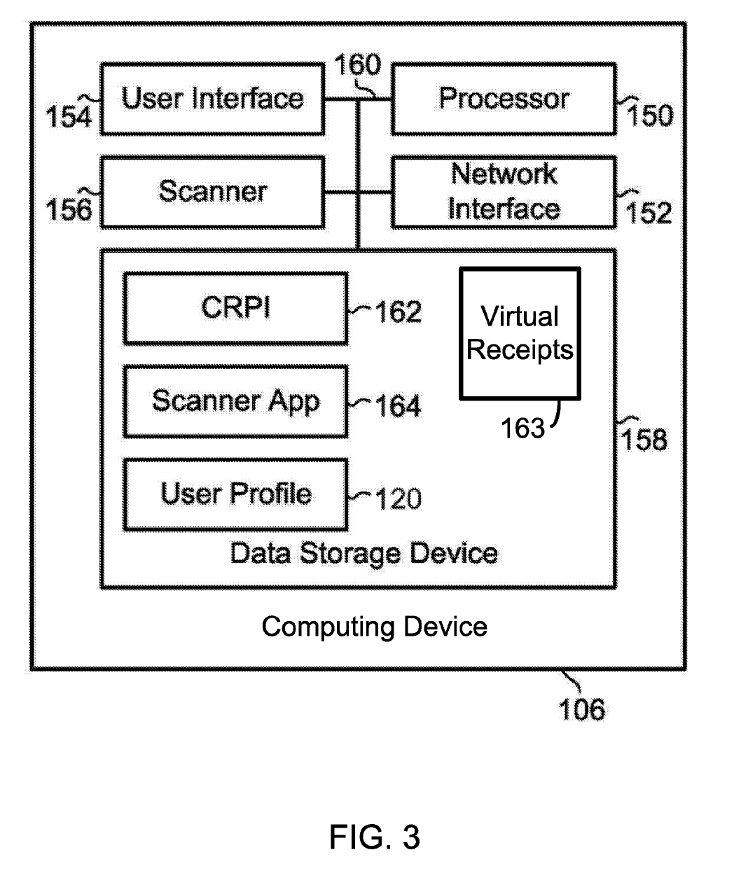

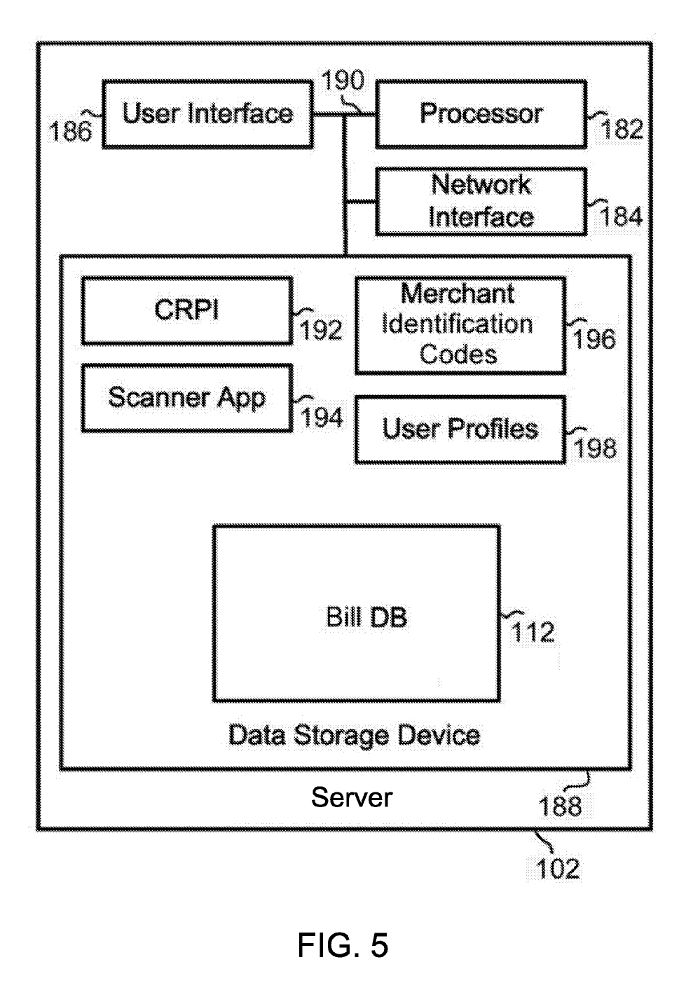

Communication between the server 102, the computing device 106 and the data analyser device 110 can be facilitated by using a server-hosted program (not shown) that is installed and executed on the server 102, a scanner application program (a ‘scanner app’) that is installed and executed on the computing device 106, and an analyser application program (an “analyser app”) that is installed and executed on the data analyser device 110. Communication between the server 102 and computing device 106 can occur using network interface 152 (shown in FIG. 3) and network interface 184 (shown in FIG. 5).

The computing device 106 can download a copy of the scanner app from a download repository (e.g., data storage device 188 in FIG. 5) and install the scanner app on the computing device 106. During or after installation, the scanner app may create a user profile 120 on the computing device 106 (e.g., within data storage device 158) and provide a prompt (e.g., by user interface 154) to provide data representing personal attributes such as, the user's first name, the user's last name, an e-mail address, a physical address and particulars of one or more payment instruments such as credit cards, debit cards, e-wallets and the like. In accordance with at least some example embodiments, the user profile 120 (e.g., the data in the user profile 120) is stored locally on the computing device 106 and is not stored on the server 102. In other examples, the server stores a user profile that is synchronized with the user profile 120 stored by the computing device 106. That is, when changes are made to the user profile 120 stored by the computing device 106, those changes are provided as updates to the user profile stored on the server 102. The updates may be provided whenever changes to the user profile 120 occur, periodically, or based on inputs received by the computing device 106. This allows for the user profile to be preserved in the event that the computing device 106 is lost, malfunctions, or is destroyed. Data transmission between the server 102 and the computing device 106 may be encrypted.

POS device 104 may be used by a merchant to generate bills for customers of the merchant's business establishment. In one embodiment, the merchant's business establishment is a restaurant and a user of the computing device 106 is a diner at the restaurant. The merchant can configure the business establishment for bill payment via 2D matrix codes or other non-textual representations of data by registering the establishment, for example, on a merchant portal website (not shown) hosted on the server 102. The server 102 can assign a unique merchant identifier to the merchant which can be stored within a merchant profile on the server 102. A merchant identifier can be referred to as an “identification code” or a “merchant identification code” as well.

In this disclosure the terms ‘user’ and ‘customer’ are used interchangeably depending on the context. For example a user of the scanner app on the computing device 106 can also be a customer of the merchant.

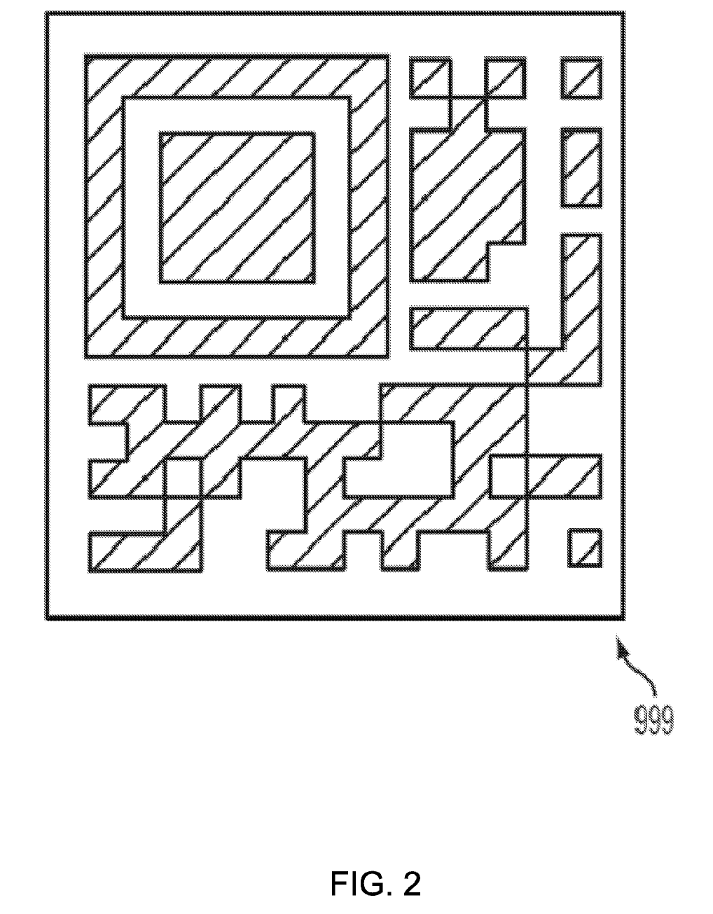

Next, FIG. 2 illustrates an example non-textual representation 999 (e.g., a 2D matrix code or QR code). Depending on the form of output device 108 of FIG. 1, the non-textual representation 999 may be printed on paper by the output device 108 or displayed on a display screen of the output device 108. In either electronic or paper form, the non-textual representation 999 may be provided to a user or customer to be scanned with the computing device 106 to initiate payment of a bill.

Next, FIG. 3 is a block diagram depicting an example embodiment of computing device 106. As shown in FIG. 3, computing device 106 includes (i) a processor 150, (ii) a network interface 152 for transmitting data to and receiving data from communication network 114, (iii) a user interface 154, (iv) a scanner 156 configured to scan (e.g., capture or detect) 2D matrix codes or other non-textual representations of data, and (v) a data storage device 158, all of which can be linked together via a system bus or other connection mechanism 160. Data storage device 158 may include computer-readable program instructions (CRPI) 162, the scanner app 164, and a user profile 120. In some examples, CRPI 162 can include the scanner app 164. Data storage device 158 can comprise a computer-readable storage medium readable by processor 150.

Data storage device 158 may also include virtual receipts 163. The virtual receipts 163 may include data representing one or more images indicating successful payment of a bill issued by a merchant. For example, the one or more images may include information such as at least one of (i) a bill identifier, (ii) a merchant identifier, (iii) an employee identifier, (iv) a location identifier, (v) an itemization of the bill, (vi) an amount paid via a payment instrument associated with the computing device 106 to a payment instrument associated with the merchant, and (vii) a table identifier. In this manner, a user may accumulate one or more such images (e.g., virtual receipts) on the user's computing device 106, thereby avoiding the need to collect paper receipts. The user interface 154 may be configured to display the images (e.g., virtual receipts) using a display screen.

Each computer-readable storage medium (or more simply “computer-readable medium”) described in this disclosure can include a non-transitory computer-readable medium that includes volatile and/or non-volatile storage components, such as optical, magnetic, organic or other memory or disc storage, which can be integrated in whole or in part with a processor. Additionally or alternatively, each computer-readable medium described in this disclosure can include a transitory computer-readable medium. The transitory computer-readable medium can include, but is not limited to, a communications medium such as a digital or analogue communications medium (e.g., a fiber optic cable, a waveguide, a wired communication link, or a wireless communication line).

Each processor described herein can comprise one or more general purpose processors (e.g., INTEL single core microprocessors or INTEL multicore microprocessors) or one or more special purpose processors (e.g., application specific integrated circuits (ASICs) or digital signal processors (DSPs)). Processor 150 is or can be configured to execute CRPI 162.

A network interface, such as network interface 152 or any other network interface disclosed herein, can include an interface to a network or communication channel. A network interface can include a transceiver having one or more transmitters configured for transmitting data over a network or communication channel to another device within or on the network or communication channel. The network interface may further include one or more receivers configured to receive data transmitted over the network or communication channel from another device within or on the network or communication channel. Any of the network interfaces disclosed herein can include circuitry, for example electronic circuitry, for converting data received from the network or communication channel to data that can be provided to a processor for processing the received data. The circuitry of the network interfaces can include a modulator and/or demodulator (modem). Any of the network interfaces disclosed herein can include circuitry, for example electronic circuitry, for converting data received from another device, such as a processor or a computer-readable medium, to data in a form that can be transmitted over a network or communication channel.

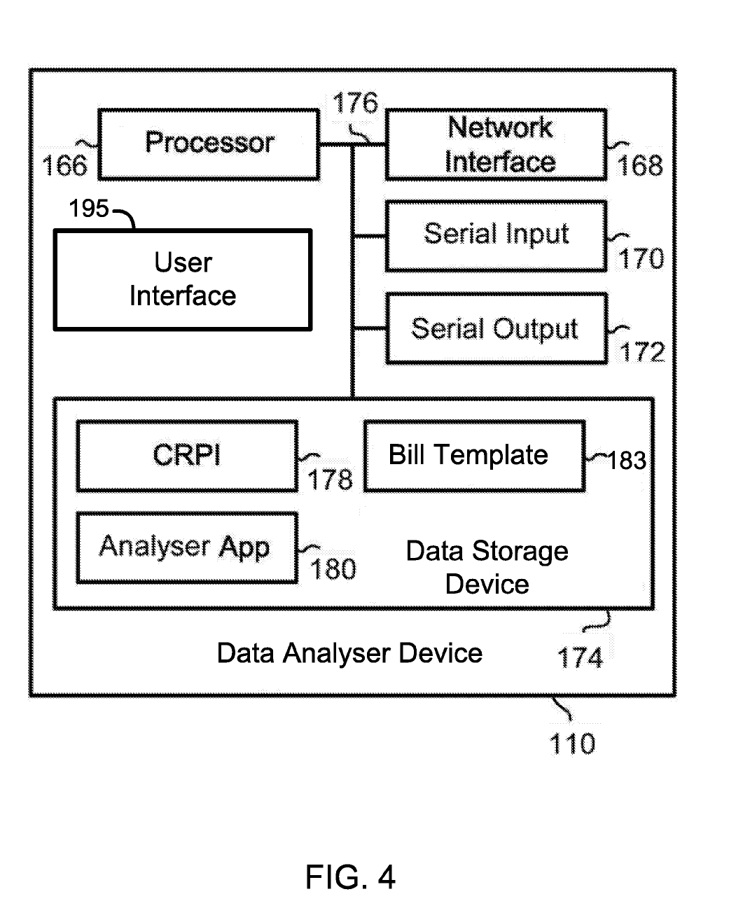

Next, FIG. 4 is a block diagram depicting an example embodiment of data analyser device 110. As shown in FIG. 4, data analyser device 110 can include (i) a processor 166, (ii) a network interface 168 for transmitting data to and receiving data from communication network 114, (iii) a serial input communication port 170 for receiving a serial bit stream from communication channel 116, (iv) a serial output communication port 172 for transmitting a serial bit stream to communication channel 118, and (v) a data storage device 174, all of which can be linked together via a system bus or other connection mechanism 176. Data storage device 174 can include (i) CRPI 178, (ii) the analyser app 180, and (iii) one or more merchant bill templates 183. CRPI 178 can include the analyser app 180. Data storage device 174 can comprise a computer-readable storage medium readable by processor 166. Processor 166 is or can be configured to execute CRPI 178. In other instances, input 170 and output 172 may comprise any single or multiple ports configured to engage in serial or non-serial (e.g., parallel) communication via channels 116 and 118. In some examples, the data analyser device 110 may include a user interface 195 configured to receive user inputs and provide outputs. For example, the user interface 195 may include a touchscreen or a display screen suitable for displaying a non-textual representation (e.g., a 2D matrix code).

Next, FIG. 5 is a block diagram depicting an example embodiment of server 102. As shown in FIG. 5, server 102 can include (i) a processor 182, (ii) a network interface 184 for transmitting data to and receiving data from communication network 114, (iii) a user interface 186, and (iv) a data storage device 188, all of which can be linked together via a system bus or other connection mechanism 190. Data storage device 188 can include (i) CRPI 192, (ii) the scanner app 194 for downloading to computing device 106, (iii) merchant identifier codes 196 for merchant businesses, (iv) user profiles 198, and (v) bill database 112. CRPI 192 can include the scanner app 194. Data storage device 188 can comprise a computer-readable storage medium readable by processor 182. Processor 182 is can be configured to execute CRPI 192. In some examples, the server 102 may include multiple networked computing devices configured to perform any functionality attributed to the server 102 in this disclosure.

The server 102 may be in communication with the computing device 106 and the data analyser device 110 via communication network 114. For example, the server 102 may receive, from the data analyser device 110, data related to bills issued by a merchant. The server 102 may also send messages to the data analyser device 110 (e.g., messages indicating whether such bills have been successfully paid). The server 102 may receive data from the computing device 106 related to such bills and related to payment instruments for initiating payment of such bills. The server 102 may also send messages to the computing device 106 indicating whether such bills have been successfully paid.

### III. Example Operation

The system 100 can be used to pay a bill at a merchant business by use of the computing device 106. The following example describes an application of the system 100 by a user (e.g., a diner) at a restaurant who wishes to pay a restaurant bill after completion of a meal. In addition to this particular example, the system 100 is also applicable to payment of any bill that is generated on a POS device 104 associated with any type of merchant. The merchant (e.g., restaurant proprietor or manager) may have registered and have been assigned a merchant identifier by the server 102. The merchant identifier may be stored on any of the server 102, the POS device 104, and the data analyser device 110.

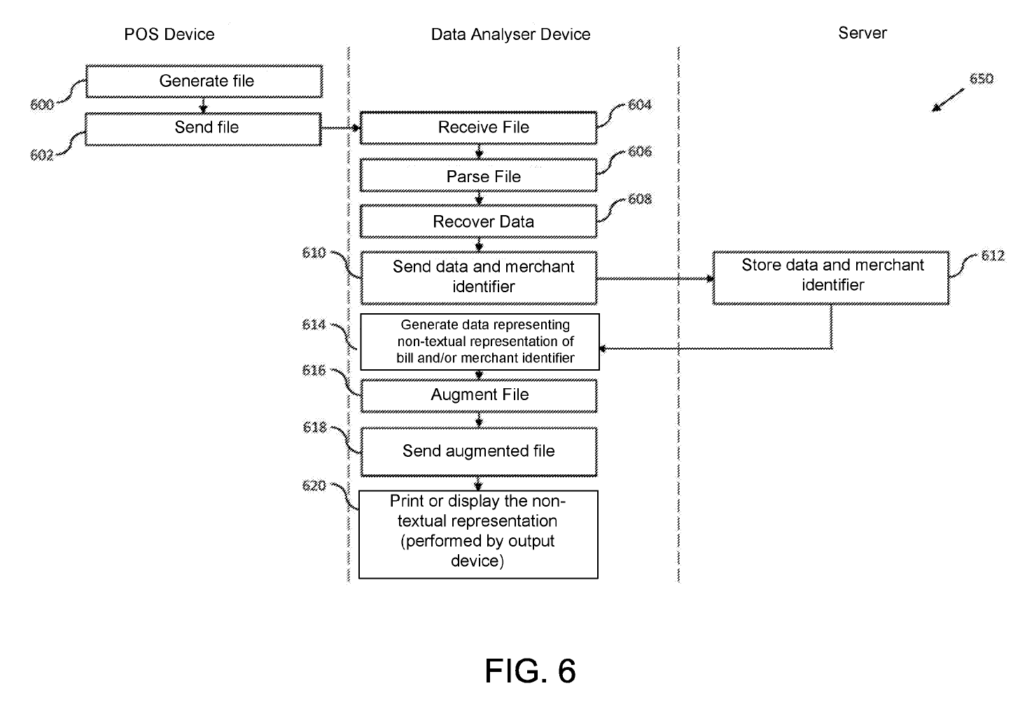

FIG. 6 is a flow chart depicting a set of functions 650 that can be carried out in accordance with an example embodiment. The set of functions 650 can be performed to generate and/or pay a bill from a merchant. The set of functions 650 are shown within blocks 600 through 620. A description of those blocks now follows.

Upon completion of a meal (or upon consumption of another good or service), the user can request a bill for payment from an employee of the merchant. The employee can produce the bill by providing inputs to the POS device 104. The provided inputs may represent, for example, one or more of a merchant identifier identifying the merchant, a bill identifier identifying the bill, a location identifier identifying a location associated with the merchant (e.g., a physical address or a store number), an employee identifier identifying an employee of the merchant (e.g., a waitperson), a table identifier identifying a table where the user/customer is sitting, an itemization of the bill, any tax such as sales tax or value-added tax included in the bill, and a total amount due. In some examples, instead of the employee providing input representing the bill identifier, the location identifier, the tax added to the bill, or the total amount due, that information may be (i) stored in memory of the POS device 104, (ii) determined or calculated by the POS device 104, or (iii) otherwise accessible to the POS device 104 and added to the bill without reference to input provided by the employee to the POS device 104. Generally, any identifier mentioned above may include any numeric, alphabetic, or alphanumeric data that identifies a corresponding object (e.g., is recognizable by the server 102, the computing device 106, or the POS device 104 as identifying the corresponding object).

At block 600, POS device 104 can generate a file that contains one or more of a (i) bill identifier, (ii) a merchant identifier, (iii) an employee identifier, (iv) a location identifier, (v) an itemization of the bill, (vi) an amount due corresponding to the bill, and (vii) a table identifier. The data of the generated file may be formatted or arranged in accordance with a bill template 183 stored on the POS device 104 or the data analyser device 110. The generated file may generally include any data representing a textual (e.g., alphanumeric) representation of the bill from the merchant. In some examples, the file may include data representing imagery related to the merchant (e.g., a merchant's logo), but may not include data representing a non-textual representation of the bill (e.g., the file may be void of data representing a non-textual representation of a (i) bill identifier, (ii) a merchant identifier, (iii) an employee identifier, (iv) a location identifier, (v) an itemization of the bill, (vi) an amount due corresponding to the bill, and (vii) a table identifier.)

At block 602 the POS device 104 may then send the generated file to the data analyser device 110 via an output port (not shown) of the POS Device 104 and communication channel 116.

At block 604, the data analyser device 110 may receive the file using serial input port 170 (or a non-serial input port of the data analyser device 110).

At block 606 the analyser app 180 in data storage device 174 of the data analyser device 110 may then parse the received file (perhaps with reference to the bill template 183) to recover, at block 608, data representing the bill corresponding to various data fields of the file (e.g., (i) a bill identifier, (ii) a merchant identifier, (iii) an employee identifier, (iv) a location identifier, (v) an itemization of the bill, (vi) an amount due corresponding to the bill, and (vii) a table identifier).

At block 610 the data analyser device 110 may then send the recovered data representing the bill to the server 102 by means of communication network 114. For example, the data analyser device 110 may send data representing at least a portion of the bill and/or the merchant identifier (e.g., data representing a non-textual representation of the bill such as a two-dimensional image, a two-dimensional matrix code, or a 2D matrix code) to be received by the server 102 so that the server 102 may associate the bill with the merchant. If the merchant identifier is not contained in the received file (e.g., the merchant identifier is not stored on POS device 104 to include within the file generated at block 600), the analyser app 180 of the data analyser device 110 retrieves the merchant identifier from data storage device 174 on the data analyser device 110 and then sends the merchant identifier to the server 102 together with the recovered data representing the bill. The server 102 may then store, at block 612, the data representing the bill and/or the merchant identifier in bill database 112 or elsewhere in data storage device 188.

At block 614, the data analyser device 110 may generate data representing a non-textual representation of the bill and/or the merchant identifier, such as a 2D matrix code (not shown), based on the contents of the received file. In an alternative embodiment, based on receiving the data representing the bill and/or the merchant identifier sent from the data analyser device 110, the server 102 may generate the non-textual representation that represents the bill and/or the merchant identifier. The server 102 may then send the generated non-textual representation to be received by the data analyser device 110 by means of communication network 114. The data representing the non-textual representation generated by the server 102 or the data analyser 110 may include at least one of (i) a two-dimensional image and (ii) a two-dimensional matrix code, such as a Quick Response (QR) code.

Whether the data analyser device 110 or the server 102 generates the data representing the non-textual representation, the data analyser device 110 may then, at block 616, augment at least a portion of the received file to include the data representing the non-textual representation of the bill and/or the merchant identifier. The data representing the non-textual representation may include data representing at least one of (i) the bill identifier, (ii) the employee identifier, (iii) the location identifier, (iv) the itemization of the bill, (v) the amount due corresponding to the bill, and (vi) the table identifier.

At block 618 the data analyser device 110 may then send the augmented file away from the data analyser device 110 to the output device 108 by means of serial output port 172 (or a non-serial port), via communication channel 118.

At block 620, the output device 108 may produce a printout or a display of the non-textual representation and/or the augmented file. In one example, the output device 108 is a printer that may print the non-textual representation, possibly along with other text or images associated with the bill according to the merchant's bill template 183. In another example, the output device 108 includes a display screen that may be used to present the non-textual representation to the user (perhaps with other text or images of the augmented file).

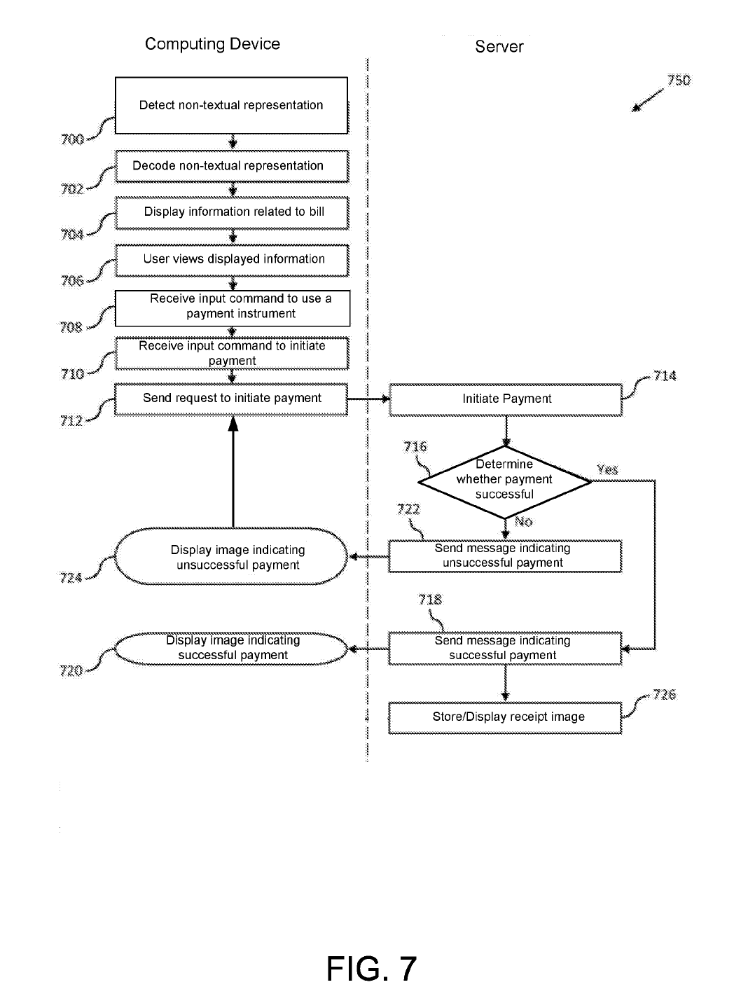

FIG. 7 is a flow chart depicting a set of functions 750 that can be carried out in accordance with an example embodiment. The set of functions 750 can be performed to pay a bill that includes a 2D matrix code that represents the bill and a corresponding merchant identifier. The set of functions 750 are shown within blocks 700 through 726.

At block 700, the computing device 106 may detect a non-textual representation of (i) a bill from a merchant and/or (ii) a merchant identifier by executing the scanner app 164 and using the scanner 156. In one example, the non-textual representation may be similar to the non-textual representation 999 of FIG. 2 (e.g., a 2D matrix code). The non-textual representation may be printed by output device 108 onto a paper copy of the bill or displayed by a display screen of the output device 108. The non-textual representation may be generated in conjunction with the data analyser device 110 augmenting at least a portion of a file received by the data analyser device 110 (e.g., from the POS device 104). The data representing the non-textual representation may include at least one of (i) a two-dimensional image and (ii) a two-dimensional matrix code, such as a Quick Response (QR) code. The file received by the data analyser device 110 may represent the bill or include data representing the bill. The augmented file may be sent from the data analyser device 110 to the output device 108.

At block 702, the scanner app 164 decodes the detected non-textual representation to recover data encoded or represented by the non-textual representation (e.g., the merchant identifier and/or data representing the bill). For example, the computing device 106 may decode the non-textual representation by executing a proprietary or open-source decoding algorithm.

At block 704, the scanner app 164 (of the computing device 106) displays information related to the bill on a display of the user interface 154. The displayed information may include an itemization of the bill (e.g., a list of items purchased and the respective costs of the purchased items), an amount of tax added to the bill, a gratuity fee added to the bill, a merchant identifier, a table identifier, an employee identifier, a location identifier, and a total amount due, among other possibilities.

At block 706, the user can view the displayed information related to the bill. The display provided by the user interface 154 of computing device 106 containing the information related to the bill may also provide the user with an option to split payment of the bill with fellow diners. In one embodiment the user may split the bill by respective items consumed among other diners. The displayed information may include check boxes or radio buttons associated with respective items consumed during the meal, which are selectable to indicate which items were consumed and therefore paid for. As respective items are selected for payment, the scanner app 164 may refresh the displayed information to show the total amount due for the selected items.

In an alternative embodiment, the information related to the bill is displayed on the user interface 154 of the computing device 106 and may also include icons that provide the diner with an option to split the bill equally, in 2, 3, 4 or 5 portions for example. In order to split the bill, the user provides input representing a selection of one of the splitting options as desired and the display on the user interface refreshes to show the amount due by the diner.

At block 708, the computing device 106 may receive input indicating a command to use a payment instrument to pay the bill. For example, the display of the user interface 154 may display icons or text representing one or more pre-loaded payment instruments, and user interface 154 may receive input indicating a selection of one or more payment instruments. The computing device 106 may have information related to the one or more payment instruments stored at user profile 120. Or, the computing device 106 may receive inputs representing information related to a new payment instrument. In another example, the information related to the one or more payment instruments may be stored by data storage device 188 of the server 102.

At block 710, user interface 154 may receive input indicating acceptance of the bill for payment. For example, the user-interface 154 may receive inputs representing a command to initiate payment of at least a portion of a total amount due corresponding to the bill. For example, the user interface 154 may receive inputs representing a command to pay a first amount due corresponding to a first item of the bill but not to pay a second amount due corresponding to a second item of the bill. Or, the received inputs may represent a command to pay a first percentage of the total amount due but not to pay a second percentage of the total amount due. In another example, the received inputs may represent a command to pay an entire amount due corresponding to the bill. An amount that a user desires to pay may depend upon an agreement among fellow diners.

For example, the (first) computing device 106 may receive a message from the server 102 or a second computing device (e.g., associated with another member of the dining party) indicating that the second computing device has received an input at least tentatively designating an amount due corresponding to a portion of the bill to be paid with a payment instrument associated with the second computing device (e.g., the other member of the dining party). The user interface 154 of the first computing device 106 may then display information indicating the tentative designation (e.g., that the tentatively designated amount due is at least tentatively designated to be paid with the payment instrument associated with the second computing device).

The first computing device 106 may also receive a message from the server 102 or the second computing device indicating that an amount due corresponding to an item of the bill has been paid with a payment instrument associated with the second computing device. The first computing device 106 may then display information within the user-interface 154 indicating that the amount due corresponding with the item has been paid with the payment instrument associated with the second computing device. In this case, such bill items corresponding to the amount paid with the payment instrument associated with the second computing device may no longer be available to be selected for payment with the payment instrument associated with the first computing device.

At block 712, the scanner app 164 (of the computing device 106) may then send a request, to be received by the server 102, to initiate payment of at least a portion of the total amount due corresponding to the bill. The request may include at least one of (i) the merchant identifier, (ii) an amount of the total amount due to be paid, (iii) a bill identifier corresponding to the bill, and (iv) information related to a payment instrument associated with the computing device. The request may also include data representing the non-textual representation of the bill, perhaps as a condensed version of data useful for facilitating payment. The merchant identifier and the bill identifier may include any numeric, alphabetic, or alphanumeric data that respectively identifies the merchant and the bill. The information related to the payment instrument associated with the computing device may include a credit or debit card number, a cardholder name, a card expiration date, a CVC, or a PIN, as stored in the user profile 120. In some examples, data related to the payment instrument associated with the computing device 106 is stored by, and retrieved from, data storage device 188 of the server 102.

If at block 708 the user interface 154 received inputs representing a command to pay a first amount due corresponding to a first item of the bill but not to pay a second amount due corresponding to a second item of the bill, then the request sent by the computing device 106 to be received by the server 102 may include a request to pay the first amount due but not the second amount due. Likewise, if the user interface 154 received inputs representing a command to pay a first percentage of the total amount due but not to pay a second percentage of the total amount due, the request sent by the computing device 106 to be received by the server 102 may include a request to pay the first percentage of the total amount due but not the second percentage of the total amount due.

At block 714, the server 102 initiates payment of the bill based on receiving the request from the computing device 106 and sends the data related to payment to a third computing device (e.g., a payment processing system/server). The third computing device (not shown) may be configured to execute payments with a payment instrument associated with the first computing device 106 or a user of the computing device 106. In some instances, initiating the payment may include the server 102 retrieving data related to the payment instrument associated with the first computing device 106 from data storage device 188. As an example, the data sent by the server 102 to the third computing device may include an amount authorized for payment, the merchant identifier, the merchant's instrument for receiving payment, and information related to the payment instrument.

If the request received by the server 102 includes a request to pay a first portion of the amount due but not a second portion of the amount due, initiating the payment of the bill may include initiating payment of the first portion of the amount due with the payment instrument associated with the computing device 106. Likewise, if the request received by the server 102 includes a request to pay a first percentage of the amount due but not a second percentage of the amount due, initiating the payment of the bill may include initiating payment of the first percentage of the amount due with a payment instrument associated with the first computing device 106.

At block 716, the server 102 may determine whether the payment was successful, perhaps by receiving a message indicating whether the payment was successful from the third computing device. A successful payment may include successful transfer of funds using the payment instrument associated with the computing device 106 to the payment instrument associated with the merchant (e.g., bank accounts). In some examples, the server 102 may be a payment processor configured to access payment instruments respectively associated with the merchant and the first computing device 106, and may internally determine whether the payment was successful.

If the payment is determined to be completed successfully, at block 718 the server 102 may send a message to be received by the scanner app 164 (of the computing device 106) and/or the data analyser 110 indicating that the payment was successful. The message may further indicate that payment of the total amount due has collectively been completed using multiple payment instruments. In the case where the message is sent to the computing device 106, the message may include names of fellow diners that contributed funds to pay the total amount due of the bill. The message may also indicate that multiple users using respective payment instruments paid for corresponding items or arbitrary percentages of the bill.

Also, the message may include data representing an image (e.g., a virtual receipt) indicating that the payment was successful or may include any information included in the message sent by the server 102. Upon receiving the message, the computing device 106 or the data analyser device 110 may store data representing the image indicating that the payment was successful. The image may depict at least one of (i) a bill identifier, (ii) a merchant identifier, (iii) an employee identifier, (iv) a location identifier, (v) an itemization of the bill, (vi) an amount paid via the payment instrument associated with the computing device 106 to the payment instrument associated with the merchant, and (vii) a table identifier. In one example, the data representing the image may be generated by the server 102, but in other examples the data representing the image could also be generated by the computing device 106 based on data within the received message. In this manner, a user may accumulate one or more such images (e.g., virtual receipts) on the user's computing device 106, thereby avoiding the need to collect paper receipts. Similarly, the merchant avoids the necessity of providing the user with a printed payment receipt.

At block 720, the user interface 154 of the computing device 106 may display the image indicating that the payment was successful.

If the completion of the payment was determined unsuccessful, at block 722 the server 102 may send a message to be received by the computing device 106 or the data analyser device 110 indicating that the payment was not completed successfully. For example, the message may include reasons for the unsuccessful payment, such as unavailability of funds associated with the payment instrument, a network malfunction, or incorrect information provided to the server 102 regarding the payment instrument. The message provided to the computing device 106 may include a prompt to provide information for another payment instrument or to retry payment with the first payment instrument.

Then at block 724, the user interface 154 of the computing device 106 may display information (i) indicating the unsuccessful payment and (ii) representing a request to re-attempt payment. For example, the display may prompt a user to provide input to the user interface 154 that includes data related to an additional payment instrument. Clearly, numerous variations and permutations are possible to the embodiments without departing from the scope of this disclosure.

Once payment is completed successfully, at block 726 the server 102 stores the data representing the image (e.g., virtual receipt) indicating that the payment was successful. Alternatively, the server 102 may store non-image data indicating that the payment was successful at the bills database 112. This data in image or non-image form may be sent to a computing device associated with the merchant for the merchant's records. The server 102 or another computing device communicatively coupled with the server 102 may be configured to display the image.

The use of non-textual representations or Quick Response (QR) codes, as described in the example embodiments, can enable user interactions in connection with bill payment at a merchant establishment to be conducted more efficiently than is possible by means of known methods. Once a user has established a user profile 120, the user need only detect, by means of the computing device 106, a non-textual representation on a display or hardcopy in order to effect payment of the bill. The user is spared the tedium of having to tender cash or a physical payment instrument such as a credit or debit card for payment. It is anticipated that the use of non-textual representations for bill payment in this manner will reduce the tedium of bill payment.

Data of the user profile 120 may be stored by the computing device 106 or by the server 102, which means that sensitive user data related to payment instruments like credit or debit cards need not be turned over to other persons such as, for example, an employee or a merchant, thus reducing the possibility of such data being misappropriated.

### VII. Additional Example Embodiments

The following examples are offered as further description of the disclosure.

### Example 1

A method comprising: receiving, by a data analyser device from a point-of-sale (POS) device, a file including data that represents a textual representation of a bill from a merchant; augmenting at least of portion of the received file to include data representing a non-textual representation of (i) the bill and (ii) a merchant identifier corresponding to the merchant, thereby generating an augmented file; and sending the augmented file away from the data analyser device to an output device.

### Example 2

The method of example 1, wherein the non-textual representation comprises at least one of (i) a two-dimensional image and (ii) a two-dimensional matrix code.

### Example 3

The method of example 2, wherein the two-dimensional matrix code includes a quick response (QR) code.

### Example 4

The method of any of examples 1-3, wherein the received file comprises data representing at least one of a (i) bill identifier, (ii) a merchant identifier, (iii) an employee identifier, (iv) a location identifier, (v) an itemization of the bill, (vi) an amount due corresponding to the bill, and (vii) a table identifier.

### Example 5

The method of any of examples 1-4, wherein the data representing the non-textual representation includes data representing at least one of a (i) bill identifier, (ii) an employee identifier, (iii) a location identifier, (iv) an itemization of the bill, (v) an amount due corresponding to the bill, and (vi) a table identifier.

### Example 6

The method of any of examples 1-5, further comprising, before augmenting the file: sending at least a portion of the received file representing the bill to a server; and receiving the data representing the non-textual representation from the server.

### Example 7

The method of any of examples 1-5, further comprising, before augmenting at least a portion of the received file, generating the data representing the non-textual representation by the data analyser device based on contents of the received file.

### Example 8

The method of any of examples 1-7, further comprising sending, to a server, at least one of (i) data representing the bill and (ii) the merchant identifier.

### Example 9

The method of any of examples 1-8, further comprising, before augmenting the received file, retrieving the merchant identifier from data storage within the data analyser device.

### Example 10

The method of any of examples 1-9, wherein the output device comprises at least one of a printer and a display screen configured to display images.

### Example 11

The method of example 10, wherein the output device comprises a printer, the method further comprising causing the printer to print the non-textual representation.

### Example 12

The method of example 10, wherein the output device comprises a display screen, the method further comprising causing the display screen to display the non-textual representation.

### Example 13

A method comprising: receiving, by a server from a data analyser device, data representing a bill from a merchant; receiving, from a computing device, a request to pay at least a portion of an amount due corresponding to the bill; initiating, by the server, payment of the bill based on receiving the request; determining, by the server, whether payment of the bill was successful; and sending, by the server, a message indicating whether payment of the bill was successful to the computing device.

### Example 14

The method of example 13, wherein the request comprises data representing a non-textual representation of the bill.

### Example 15

The method of any of examples 13-14, wherein the received data comprises data representing a non-textual representation of the bill.

### Example 16

The method of any of examples 14-15, wherein the non-textual representation comprises at least one of (i) a two-dimensional image and (ii) a two-dimensional matrix code.

### Example 17

The method of example 16, wherein the two-dimensional matrix code is a quick response (QR) code.

### Example 18

The method of any of examples 13-17, further comprising receiving a merchant identifier corresponding to the merchant from the data analyser device.

### Example 19

The method of any of examples 13-18, further comprising: generating data representing a non-textual representation of (i) the bill and (ii) the merchant identifier; and sending the generated data to the data analyser device.

### Example 20

The method of any of examples 13-19, further comprising storing the data received from the data analyser device within data storage of the server.

### Example 21

The method of any of examples 13-20, wherein the request comprises a request to pay a first portion of the amount due corresponding to a first item of the bill but not to pay a second portion of the amount due corresponding to a second item of the bill.

### Example 22

The method of example 21, wherein initiating payment of the bill comprises initiating payment of the first portion of the amount due with a payment instrument associated with the computing device.

### Example 23

The method of any of examples 13-20, wherein the request comprises a request to pay a first percentage of the amount due but not to pay a second percentage of the amount due.

### Example 24

The method of example 23, wherein initiating payment of the bill comprises initiating payment of the first percentage of the amount due with a payment instrument associated with the computing device.

### Example 25

The method of any of examples 13-24, further comprising sending, to the data analyser device or another computing device associated with the merchant, a message indicating whether the payment of the amount due was successful.

### Example 26

The method of any of examples 13-25, wherein the request includes at least one of (i) a merchant identifier corresponding to the merchant, (ii) a bill identifier corresponding to the bill, (iii) an amount to be paid with a payment instrument associated with the computing device, and (iv) information related to the payment instrument.

### Example 27

The method of any of examples 13-26, further comprising retrieving data related to a payment instrument associated with the computing device from data storage within the server.

### Example 28

The method of any of examples 13-27, wherein the computing device is a first computing device and initiating payment of the bill comprises sending data to a second computing device associated with a payment instrument associated with the first computing device.

### Example 29

A method comprising: detecting, by a computing device, a non-textual representation of (i) a bill from a merchant and (ii) a merchant identifier, wherein the non-textual representation is generated by a data analyser device augmenting at least a portion of a received file representing the bill to generate an augmented file that is sent to an output device; based on the detected representation, displaying information related to the bill by a user-interface of the computing device; receiving, by the user-interface, input representing a command to initiate payment of at least a portion of a total amount due corresponding to the bill; and based on receiving the input, sending, to a server, a request to initiate payment of at least a portion of the total amount due.

### Example 30

The method of example 29, wherein the non-textual representation comprises at least one of (i) a two-dimensional image and (ii) a two-dimensional matrix code.

### Example 31

The method of example 30, wherein the two-dimensional matrix code is a quick response (QR) code.

### Example 32

The method of any of examples 29-31, wherein the request comprises at least one of (i) the merchant identifier, (ii) an amount of the total amount due to be paid, (iii) a bill identifier corresponding to the bill, and (iv) information related to a payment instrument associated with the computing device.

### Example 33

The method of any of examples 29-32, further comprising: receiving, from the server, a message indicating whether the payment was completed successfully; and displaying by the user-interface information indicating whether the payment was completed successfully.

### Example 34

The method of example 33, wherein the message further indicates that payment of the total amount due has been completed via multiple payment instruments and the displayed information further indicates that payment of the total amount due has been completed via multiple payment instruments.

### Example 35

The method of any of examples 29-34, further comprising: receiving, from the server, a message indicating that the payment was successful; and storing data representing an image indicating that the payment was successful.

### Example 36

The method of example 35, wherein the image is generated by the server.

### Example 37

The method of any of examples 34-36, further comprising displaying the image by a display of the user-interface.

### Example 38

The method of any of examples 34-37, wherein the image comprises an itemization of the bill and indications of corresponding amounts of the bill that were paid using a payment instrument associated with the computing device.

### Example 39

The method of any of examples 29-38, wherein the received input represents a command to pay a first amount due corresponding to a first item of the bill but not to pay a second amount due corresponding to a second item of the bill, and wherein the request includes a request to pay the first amount due but not the second amount due.

### Example 40

The method of any of examples 29-39, wherein the received input represents a command to pay a first percentage of the total amount due but not to pay a second percentage of the total amount due, and wherein the request includes a request to pay the first percentage of the total amount due but not the second percentage of the total amount due.

### Example 41

The method of any of examples 29-40, wherein the computing device is a first computing device, the method further comprising: receiving a message from the server or a second computing device indicating that the second computing device has received an input at least tentatively designating an amount due corresponding to a portion of the bill to be paid with a payment instrument associated with the second computing device; and causing display of information by the user-interface indicating that the amount due corresponding to the portion of the bill is at least tentatively designated to be paid with the payment instrument associated with the second computing device.

### Example 42

The method of example 41, the method further comprising: receiving a message from the server or a second computing device indicating that an amount due corresponding to an item of the bill has been paid with a payment instrument associated with the second computing device; and causing display of information within the user-interface indicating that the amount due corresponding with the item has been paid with the payment instrument associated with the second computing device.

### Example 43

The method of any of examples 29-33 and 39-40, further comprising: receiving, from the server, a message indicating that the payment was not completed successfully; and displaying information by the user-interface (i) indicating the unsuccessful payment and (ii) representing a request to re-attempt payment.

### Example 44

A computer-readable medium storing instructions that when executed by a data analyser device cause the data analyser device to perform functions comprising: receiving from a point-of-sale (POS) device, a file including data that represents a textual representation of a bill from a merchant; augmenting at least of portion of the received file to include data representing a non-textual representation of (i) the bill and (ii) a merchant identifier corresponding to the merchant, thereby generating an augmented file; and sending the augmented file away from the data analyser device to an output device.

### Example 45

The computer-readable medium of example 44, wherein the non-textual representation comprises at least one of (i) a two-dimensional image and (ii) a two-dimensional matrix code.

### Example 46

The computer-readable medium of example 45, wherein the two-dimensional matrix code includes a quick response (QR) code.

### Example 47

The computer-readable medium of any of examples 44-46, wherein the received file comprises data representing at least one of a (i) bill identifier, (ii) a merchant identifier, (iii) an employee identifier, (iv) a location identifier, (v) an itemization of the bill, (vi) an amount due corresponding to the bill, and (vii) a table identifier.

### Example 48

The computer-readable medium of any of examples 44-47, wherein the data representing the non-textual representation includes data representing at least one of a (i) bill identifier, (ii) an employee identifier, (iii) a location identifier, (iv) an itemization of the bill, (v) an amount due corresponding to the bill, and (vi) a table identifier.

### Example 49

The computer-readable medium of any of examples 44-48, wherein the functions further comprise, before augmenting the file: sending at least a portion of the received file representing the bill to a server; and receiving the data representing the non-textual representation from the server.

### Example 50

The computer-readable medium of any of examples 44-48, wherein the functions further comprise, before augmenting at least a portion of the received file, generating the data representing the non-textual representation by the data analyser device based on contents of the received file.

### Example 51

The computer-readable medium of any of examples 44-50, wherein the functions further comprise sending, to a server, at least one of (i) data representing the bill and (ii) the merchant identifier.

### Example 52

The computer-readable medium of any of examples 44-51, wherein the functions further comprise, before augmenting the received file, retrieving the merchant identifier from data storage within the data analyser device.

### Example 53

The computer-readable medium of any of examples 44-52, wherein the output device comprises at least one of a printer and a display screen configured to display images.

### Example 54

The computer-readable medium of example 53, wherein the output device comprises a printer, the functions further comprising causing the printer to print the non-textual representation.

### Example 55

The computer-readable medium of example 53, wherein the output device comprises a display screen, the functions further comprising causing the display screen to display the non-textual representation.

### Example 56

The computer-readable medium of any of examples 44-55, wherein the computer-readable medium is a non-transitory computer-readable medium.

### Example 57

A computer-readable medium storing instructions that when executed by a server cause the server to perform functions comprising: receiving, from a data analyser device, data representing a bill from a merchant; receiving, from a computing device, a request to pay at least a portion of an amount due corresponding to the bill; initiating payment of the bill based on receiving the request; determining whether payment of the bill was successful; and sending a message indicating whether payment of the bill was successful to the computing device.

### Example 58

The computer-readable medium of example 57, wherein the request comprises data representing a non-textual representation of the bill.

### Example 59

The computer-readable medium of any of examples 57-58, wherein the received data comprises data representing a non-textual representation of the bill.

### Example 60

The computer-readable medium of any of examples 58-59, wherein the non-textual representation comprises at least one of (i) a two-dimensional image and (ii) a two-dimensional matrix code.

### Example 61

The computer-readable medium of example 60, wherein the two-dimensional matrix code is a quick response (QR) code.

### Example 62

The computer-readable medium of any of examples 57-61, the functions further comprising receiving a merchant identifier corresponding to the merchant from the data analyser device.

### Example 63

The computer-readable medium of any of examples 57-62, the functions further comprising: generating data representing a non-textual representation of (i) the bill and (ii) the merchant identifier; and sending the generated data to the data analyser device.

### Example 64

The computer-readable medium of any of examples 57-63, the functions further comprising storing the data received from the data analyser device within data storage of the server.

### Example 65

The computer-readable medium of any of examples 57-64, wherein the request comprises a request to pay a first portion of the amount due corresponding to a first item of the bill but not to pay a second portion of the amount due corresponding to a second item of the bill.

### Example 66

The computer-readable medium of example 65, wherein initiating payment of the bill comprises initiating payment of the first portion of the amount due with a payment instrument associated with the computing device.

### Example 67

The computer-readable medium of any of examples 57-64, wherein the request comprises a request to pay a first percentage of the amount due but not to pay a second percentage of the amount due.

### Example 68

The computer-readable medium of example 67, wherein initiating payment of the bill comprises initiating payment of the first percentage of the amount due with a payment instrument associated with the computing device.

### Example 69

The computer-readable medium of any of examples 57-68, the functions further comprising sending, to the data analyser device or another computing device associated with the merchant, a message indicating whether the payment of the amount due was successful.

### Example 70

The computer-readable medium of any of examples 57-69, wherein the request includes at least one of (i) a merchant identifier corresponding to the merchant, (ii) a bill identifier corresponding to the bill, (iii) an amount to be paid with a payment instrument associated with the computing device, and (iv) information related to the payment instrument.

### Example 71

The computer-readable medium of any of examples 57-70, the functions further comprising retrieving data related to a payment instrument associated with the computing device from data storage within the server.

### Example 72

The computer-readable medium of any of examples 57-71, wherein the computing device is a first computing device and initiating payment of the bill comprises sending data to a second computing device associated with a payment instrument associated with the first computing device.

### Example 73

The computer-readable medium of any of examples 57-72, wherein the computer-readable medium is a non-transitory computer-readable medium.

### Example 74

A computer-readable medium storing instructions that when executed by a computing device cause the computing device to perform functions comprising: detecting a non-textual representation of (i) a bill from a merchant and (ii) a merchant identifier, wherein the non-textual representation is generated by a data analyser device augmenting at least a portion of a received file representing the bill to generate an augmented file that is sent to an output device; based on the detected representation, displaying information related to the bill by a user-interface of the computing device; receiving, by the user-interface, input representing a command to initiate payment of at least a portion of a total amount due corresponding to the bill; and based on receiving the input, sending, to a server, a request to initiate payment of at least a portion of the total amount due.

### Example 75

The computer-readable medium of example 74, wherein the non-textual representation comprises at least one of (i) a two-dimensional image and (ii) a two-dimensional matrix code.

### Example 76

The computer-readable medium of example 75, wherein the two-dimensional matrix code is a quick response (QR) code.

### Example 77

The computer-readable medium of any of examples 74-76, wherein the request comprises at least one of (i) the merchant identifier, (ii) an amount of the total amount due to be paid, (iii) a bill identifier corresponding to the bill, and (iv) information related to a payment instrument associated with the computing device.

### Example 78

The computer-readable medium of any of examples 74-77, the functions further comprising: receiving, from the server, a message indicating whether the payment was completed successfully; and displaying by the user-interface information indicating whether the payment was completed successfully.

### Example 79

The computer-readable medium of example 78, wherein the message further indicates that payment of the total amount due has been completed via multiple payment instruments and the displayed information further indicates that payment of the total amount due has been completed via multiple payment instruments.

### Example 80

The computer-readable medium of any of examples 74-79, the functions further comprising: receiving, from the server, a message indicating that the payment was successful; and storing data representing an image indicating that the payment was successful.

### Example 81

The computer-readable medium of example 80, wherein the image is generated by the server.

### Example 82

The computer-readable medium of any of examples 79-81, the functions further comprising displaying the image by the display of the user-interface.

### Example 83

The computer-readable medium of any of examples 79-81, wherein the image comprises an itemization of the bill and indications of corresponding amounts of the bill that were paid using a payment instrument associated with the computing device.

### Example 84

The computer-readable medium of any of examples 74-83, wherein the received input represents a command to pay a first amount due corresponding to a first item of the bill but not to pay a second amount due corresponding to a second item of the bill, and wherein the request includes a request to pay the first amount due but not the second amount due.

### Example 85

The computer-readable medium of any of examples 74-84, wherein the received input represents a command to pay a first percentage of the total amount due but not to pay a second percentage of the total amount due, and wherein the request includes a request to pay the first percentage of the total amount due but not the second percentage of the total amount due.

### Example 86

The computer-readable medium of any of examples 74-85, wherein the computing device is a first computing device, the functions further comprising: receiving a message from the server or a second computing device indicating that the second computing device has received an input at least tentatively designating an amount due corresponding to a portion of the bill to be paid with a payment instrument associated with the second computing device; and causing display of information by the user-interface indicating that the amount due corresponding to the portion of the bill is at least tentatively designated to be paid with the payment instrument associated with the second computing device.

### Example 87

The computer-readable medium of example 86, the functions further comprising: receiving a message from the server or a second computing device indicating that an amount due corresponding to an item of the bill has been paid with a payment instrument associated with the second computing device; and causing display of information within the user-interface indicating that the amount due corresponding with the item has been paid with the payment instrument associated with the second computing device.

### Example 88

The computer-readable medium of any of examples 74-78 and 84-86, the functions further comprising: receiving, from the server, a message indicating that the payment was not completed successfully; and displaying information by the user-interface (i) indicating the unsuccessful payment and (ii) representing a request to re-attempt payment.

### Example 89

The computer-readable medium of any of examples 74-88, wherein the computer-readable medium is a non-transitory computer-readable medium.

### Example 90

A data analyser device comprising: a processor; and a computer-readable medium storing instructions that when executed by the processor cause the data analyser device to perform functions comprising: receiving, from a point-of-sale (POS) device, a file including data that represents a textual representation of a bill from a merchant; augmenting at least of portion of the received file to include data representing a non-textual representation of (i) the bill and (ii) a merchant identifier corresponding to the merchant, thereby generating an augmented file; and sending the augmented file away from the data analyser device to an output device.

### Example 91

The data analyser device of example 90, wherein the non-textual representation comprises at least one of (i) a two-dimensional image and (ii) a two-dimensional matrix code.

### Example 92

The data analyser device of example 91, wherein the two-dimensional matrix code includes a quick response (QR) code.

### Example 93

The data analyser device of any of examples 90-92, wherein the received file comprises data representing at least one of a (i) bill identifier, (ii) a merchant identifier, (iii) an employee identifier, (iv) a location identifier, (v) an itemization of the bill, (vi) an amount due corresponding to the bill, and (vii) a table identifier.

### Example 94

The data analyser device of any of examples 90-93, wherein the data representing the non-textual representation includes data representing at least one of a (i) bill identifier, (ii) an employee identifier, (iii) a location identifier, (iv) an itemization of the bill, (v) an amount due corresponding to the bill, and (vi) a table identifier.

### Example 95

The data analyser device of any of examples 90-94, the functions further comprising, before augmenting the file: sending at least a portion of the received file representing the bill to a server; and receiving the data representing the non-textual representation from the server.

### Example 96

The data analyser device of any of examples 90-94, the functions further comprising, before augmenting at least a portion of the received file, generating the data representing the non-textual representation by the data analyser device based on contents of the received file.

### Example 97

The data analyser device of any of examples 90-96, the functions further comprising sending, to a server, at least one of (i) data representing the bill and (ii) the merchant identifier.

### Example 98

The data analyser device of any of examples 90-97, the functions further comprising, before augmenting the received file, retrieving the merchant identifier from data storage within the data analyser device.

### Example 99

The data analyser device of any of examples 90-98, wherein the output device comprises at least one of a printer and a display screen configured to display images.

### Example 100

The data analyser device of example 99, wherein the output device comprises a printer, the functions further comprising causing the printer to print the non-textual representation.

### Example 101

The data analyser device of example 99, wherein the output device comprises a display screen, the functions further comprising causing the display screen to display the non-textual representation.

### Example 102

The data analyser device of any of examples 90-101, wherein the computer-readable medium is a non-transitory computer-readable medium.

### Example 103

A server comprising: a processor; and a computer-readable medium storing instructions that when executed by the processor cause the server to perform functions comprising: receiving, from a data analyser device, data representing a bill from a merchant; receiving, from a computing device, a request to pay at least a portion of an amount due corresponding to the bill; initiating payment of the bill based on receiving the request; determining whether payment of the bill was successful; and sending a message indicating whether payment of the bill was successful to the computing device.

### Example 104

The server of example 103, wherein the request comprises data representing a non-textual representation of the bill.

### Example 105

The server of any of examples 103-104, wherein the received data comprises data representing a non-textual representation of the bill.

### Example 106

The server of any of examples 104-105, wherein the non-textual representation comprises at least one of (i) a two-dimensional image and (ii) a two-dimensional matrix code.

### Example 107

The server of example 106, wherein the two-dimensional matrix code is a quick response (QR) code.

### Example 108

The server of any of examples 103-107, the functions further comprising receiving a merchant identifier corresponding to the merchant from the data analyser device.

### Example 109

The server of any of examples 103-108, the functions further comprising: generating data representing a non-textual representation of (i) the bill and (ii) the merchant identifier; and sending the generated data to the data analyser device.

### Example 110

The server of any of examples 103-109, the functions further comprising storing the data received from the data analyser device within data storage of the server.

### Example 111

The server of any of examples 103-110, wherein the request comprises a request to pay a first portion of the amount due corresponding to a first item of the bill but not to pay a second portion of the amount due corresponding to a second item of the bill.

### Example 112

The server of example 111, wherein initiating payment of the bill comprises initiating payment of the first portion of the amount due with a payment instrument associated with the computing device.

### Example 113

The server of any of examples 103-110, wherein the request comprises a request to pay a first percentage of the amount due but not to pay a second percentage of the amount due.

### Example 114

The server of example 113, wherein initiating payment of the bill comprises initiating payment of the first percentage of the amount due with a payment instrument associated with the computing device.

### Example 115

The server of any of examples 103-114, the functions further comprising sending, to the data analyser device or another computing device associated with the merchant, a message indicating whether the payment of the amount due was successful.

### Example 116

The server of any of examples 103-115, wherein the request includes at least one of (i) a merchant identifier corresponding to the merchant, (ii) a bill identifier corresponding to the bill, (iii) an amount to be paid with a payment instrument associated with the computing device, and (iv) information related to the payment instrument.

### Example 117

The server of any of examples 103-116, the functions further comprising retrieving data related to a payment instrument associated with the computing device from data storage within the server.

### Example 118

The server of any of examples 103-117, wherein the computing device is a first computing device and initiating payment of the bill comprises sending data to a second computing device associated with a payment instrument associated with the first computing device.

### Example 119

The server of any of examples 103-118, wherein the computer-readable medium is a non-transitory computer-readable medium.

### Example 120

A computing device comprising: a processor; and a computer-readable medium storing instructions that when executed by the processor cause the computing device to perform functions comprising: detecting a non-textual representation of (i) a bill from a merchant and (ii) a merchant identifier, wherein the non-textual representation is generated by a data analyser device augmenting at least a portion of a received file representing the bill to generate an augmented file that is sent to an output device; based on the detected representation, displaying information related to the bill by a user-interface of the computing device; receiving, by the user-interface, input representing a command to initiate payment of at least a portion of a total amount due corresponding to the bill; and based on receiving the input, sending, to a server, a request to initiate payment of at least a portion of the total amount due.

### Example 121

The computing device of example 120, wherein the non-textual representation comprises at least one of (i) a two-dimensional image and (ii) a two-dimensional matrix code.

### Example 122

The computing device of example 121, wherein the two-dimensional matrix code is a quick response (QR) code.

### Example 123

The computing device of any of examples 120-122, wherein the request comprises at least one of (i) the merchant identifier, (ii) an amount of the total amount due to be paid, (iii) a bill identifier corresponding to the bill, and (iv) information related to a payment instrument associated with the computing device.

### Example 124

The computing device of any of examples 120-123, the functions further comprising: receiving, from the server, a message indicating whether the payment was completed successfully; and displaying by the user-interface information indicating whether the payment was completed successfully.

### Example 125

The computing device of example 124, wherein the message further indicates that payment of the total amount due has been completed via multiple payment instruments and the displayed information further indicates that payment of the total amount due has been completed via multiple payment instruments.

### Example 126

The computing device of any of examples 120-125, the functions further comprising: receiving, from the server, a message indicating that the payment was successful; and storing data representing an image indicating that the payment was successful.

### Example 127

The computing device of example 126, wherein the image is generated by the server.

### Example 128

The computing device of any of examples 125-127, the functions further comprising displaying the image by a display of the user-interface.

### Example 129

The computing device of any of examples 125-128, wherein the image comprises an itemization of the bill and indications of corresponding amounts of the bill that were paid using a payment instrument associated with the computing device.

### Example 130

The computing device of any of examples 120-129, wherein the received input represents a command to pay a first amount due corresponding to a first item of the bill but not to pay a second amount due corresponding to a second item of the bill, and wherein the request includes a request to pay the first amount due but not the second amount due.

### Example 131

The computing device of any of examples 120-130, wherein the received input represents a command to pay a first percentage of the total amount due but not to pay a second percentage of the total amount due, and wherein the request includes a request to pay the first percentage of the total amount due but not the second percentage of the total amount due.

### Example 132

The computing device of any of examples 120-131, wherein the computing device is a first computing device, the functions further comprising: receiving a message from the server or a second computing device indicating that the second computing device has received an input at least tentatively designating an amount due corresponding to a portion of the bill to be paid with a payment instrument associated with the second computing device; and causing display of information by the user-interface indicating that the amount due corresponding to the portion of the bill is at least tentatively designated to be paid with the payment instrument associated with the second computing device.

### Example 133

The computing device of example 132, the functions further comprising: receiving a message from the server or a second computing device indicating that an amount due corresponding to an item of the bill has been paid with a payment instrument associated with the second computing device; and causing display of information within the user-interface indicating that the amount due corresponding with the item has been paid with the payment instrument associated with the second computing device.

### Example 134

The computing device of any of examples 120-133 and 130-131, the functions further comprising: receiving, from the server, a message indicating that the payment was not completed successfully; and displaying information by the user-interface (i) indicating the unsuccessful payment and (ii) representing a request to re-attempt payment.

### Example 135

The computing device of any of examples 120-134, wherein the computer-readable medium is a non-transitory computer-readable medium.

### VIII. Conclusion

Example embodiments have been described above. Those skilled in the art will understand that changes and modifications can be made to the described embodiments without departing from the true scope and spirit of the present invention, which is defined by the claims.

This detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be used, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including in substantially concurrent or in reverse order, depending on the functionality involved. Further, more or fewer steps, blocks and/or functions can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk or hard drive or other storage media.

The computer-readable medium can include non-transitory computer-readable media such as computer-readable media that stores data for short periods of time like register memory, processor cache, and/or random access memory (RAM). The computer-readable media can include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media can be any other volatile or non-volatile storage systems. A computer-readable medium can be considered a computer-readable storage medium, for example, or a tangible storage device.

Software for use in carrying out the invention can also be in transitory form, for example in the form of signals transmitted over a network such as the Internet. Moreover, a step or block that represents one or more information transmissions can correspond to information transmissions between software and/or hardware modules in the same physical device. However, other information transmissions can be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting.

1. A method comprising:
receiving, by a processor of a data analyzer device from a point-of-sale (POS) device, a file including data that represents a textual representation of a bill from a merchant;
augmenting, by the data analyzer, at least of portion of the received file to include data representing a non-textual representation of (i) the bill and (ii) a merchant identifier corresponding to the merchant, thereby generating an augmented file; and
sending, by the data analyzer, the augmented file to an output device.

2. The method of claim 1, wherein the non-textual representation comprises at least one of (i) a two-dimensional image, (ii) a two-dimensional matrix code, or (iii) a quick response (QR) code.

3. (canceled)

4. The method of claim 1,
wherein the received file comprises data representing at least one of: (i) a bill identifier, (ii) a merchant identifier, (iii) an employee identifier, (iv) a location identifier, (v) an itemization of the bill, (vi) an amount due corresponding to the bill, or (vii) a table identifier, and
wherein the data representing the non-textual representation comprises data representing at least one of: (i) the bill identifier, (ii) the employee identifier, (iii) the location identifier, (iv) the itemization of the bill, (v) the amount due corresponding to the bill, or (vi) the table identifier.

5. (canceled)

6. The method of claim 1, further comprising, before augmenting the file:
sending, by the data analyzer device, at least a portion of the received file representing the bill to a server; and
receiving, by the data analyzer device, the data representing the non-textual representation from the server. 7-11. (canceled)

12. The method of claim 1, wherein the output device comprises a display screen, the method further comprising causing the display screen to display the non-textual representation.

13. A method comprising:
receiving, by a server from a data analyzer device, data representing a bill from a merchant;
receiving, by the server from a computing device, a request to pay at least a portion of an amount due corresponding to the bill;
initiating, by the server, payment of the bill based on receiving the request;
determining, by the server, whether payment of the bill was successful; and
sending, by the server, a message indicating whether payment of the bill was successful to the computing device.

14-15. (canceled)

16. The method of claim 13,
wherein at least one of the request or the received data comprises data representing a non-textual representation of the bill,
wherein the non-textual representation comprises at least one of (i) a two-dimensional image and (ii) a two-dimensional matrix code, and
wherein the non-textual representation comprises at least one of (i) a two dimensional image, (ii) a two-dimensional matrix code, or (iii) a quick response code.

17-20. (canceled)

21. The method of claim 13, wherein the request comprises (i) a request to pay a first portion of the amount due corresponding to a first item of the bill but not to pay a second portion of the amount due corresponding to a second item of the bill, or (ii) a request to pay a first percentage of the amount due but not to pay a second percentage of the amount due.

22. The method of claim 21, wherein initiating payment of the bill comprises (i) initiating payment of the first portion of the amount due with a payment instrument associated with the computing device if the request comprises the request to pay the first portion of the amount due corresponding to the first item of the bill but not to pay the second portion of the amount due corresponding to the second item of the bill, or (ii) initiating payment of the bill comprises initiating payment of the first percentage of the amount due with a payment instrument associated with the computing device if the request comprises the request to pay the first percentage of the amount due but not to pay the second percentage of the amount due.

23-27. (canceled)

28. The method of claim 13, wherein the computing device is a first computing device and initiating payment of the bill comprises sending data to a second computing device associated with a payment instrument associated with the first computing device.

29. A method comprising:
detecting, by a computing device, a non-textual representation of (i) a bill from a merchant and (ii) a merchant identifier, wherein the non-textual representation is generated by a data analyzer device augmenting at least a portion of a received file representing the bill to generate an augmented file that is sent to an output device;
based on the detected non-textual representation, displaying information related to the bill by a user-interface of the computing device;
receiving, by the user-interface, input representing a command to initiate payment of at least a portion of a total amount due corresponding to the bill; and
based on receiving the input, sending, to a server by the computing device, a request to initiate payment of at least a portion of the total amount due.

30. The method of claim 29, wherein the non-textual representation comprises at least one of (i) a two-dimensional image, (ii) a two-dimensional matrix code, or (iii) a quick response (QR) code.

31. (canceled)

32. The method of claim 29, wherein the request comprises at least one of (i) the merchant identifier, (ii) an amount of the total amount due to be paid, (iii) a bill identifier corresponding to the bill, and (iv) information related to a payment instrument associated with the computing device.

33. (canceled)

34. The method of claim 29, further comprising:
receiving, by the computing device from the server, a message indicating the payment was completed successfully via multiple payment instruments; and
displaying, by the user interface, information indicating the payment was completed successfully and payment of the total amount due has been completed via multiple payment instruments.

35-37. (canceled)

38. The method of claim 29, further comprising:
receiving, by the computing device from the server, a message indicating the payment was successful;
storing, by the computing device, data representing an image indicating the payment was successful; and
displaying, by the user-interface of the computing device, the image indicating the payment was successful,
wherein the displayed image depicts an itemization of the bill and indications of corresponding amounts of the bill that were paid using a payment instrument associated with the computing device.

39. The method of claim 29,
wherein the received input represents a command to pay a first amount due corresponding to a first item of the bill but not to pay a second amount due corresponding to a second item of the bill, and
wherein the request includes a request to pay the first amount due but not the second amount due.

40. The method of claim 29,
wherein the received input represents a command to pay a first percentage of the total amount due but not to pay a second percentage of the total amount due, and
wherein the request includes a request to pay the first percentage of the total amount due but not the second percentage of the total amount due.

41. The method of claim 29, wherein the computing device is a first computing device, the method further comprising:
receiving, by the first computing device, a message from the server or a second computing device indicating that the second computing device has received an input at least tentatively designating an amount due corresponding to a portion of the bill to be paid with a payment instrument associated with the second computing device; and
causing display of information by the user-interface indicating that the amount due corresponding to the portion of the bill is at least tentatively designated to be paid with the payment instrument associated with the second computing device.

42. The method of claim 41, further comprising:
receiving, by the first computing device, a message from the server or the second computing device indicating that an amount due corresponding to an item of the bill has been paid with a payment instrument associated with the second computing device; and
causing display of information within the user-interface indicating that the amount due corresponding with the item has been paid with the payment instrument associated with the second computing device.

43. The method of claim 29, further comprising:
receiving, by the computing device from the server, a message indicating that the payment was not completed successfully; and
displaying information by the user-interface (i) indicating the unsuccessful payment and (ii) representing a request to re-attempt payment.

44-135. (canceled)
